(19) United States
(12) Patent Application Publication
(10) Pub. No.: US 2008/0291966 A1
(43) Pub. Date: Nov. 27, 2008

(54) Thermal conductivity detector (TCD) having compensated constant temperature element

(76) Inventors: Steven J. Engel, Kennett Square, PA (US); Heng He, Wilmington, DE (US); Steven J. O'Kane, Newark, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/805,694

(22) Filed: May 24, 2007

(51) Int. Cl. G01K 17/00

(52) U.S. Cl. 374/29

(57) ABSTRACT

A thermal conductivity detector (TCD) includes a detector cell body having a plurality of fluid cavities, at least one detector element associated with each of the plurality of fluid cavities, and a control circuit associated with each of the at least one detector elements, wherein the control circuit varies the power to the at least one detector element to maintain the at least one detector element at a constant temperature. Power compensation and temperature compensation are also provided to minimize temperature variation of the body of the TCD cell.

### BACKGROUND

Gas chromatography (GC) is used to separate and detect different compounds in a sample mixture. One of the common methods for performing gas chromatography uses columns to separate the sample gas into its constituent compounds. The interior surface of the column is typically an inert material that is coated with, or has adsorbed onto it, a material referred to as the “stationary phase.” The sample mixture is introduced into the column through a sample inlet device preferably in what is referred to as a “plug” and is transported through the column using an inert carrier gas, which is referred to as the “mobile phase.” When the sample gas encounters the stationary phase, the different components in the sample gas are attracted differently to the stationary phase, causing the different components in the sample gas to travel through the system at different speeds. Separation occurs by the differential retardation of sample components through interaction with the stationary phase as they are driven through the column by the mobile phase. Each sample component will have a characteristic delay between the time it was introduced into the chromatographic system and the time that it is detected after it elutes from the separation column. This characteristic time is called its “retention time.” Some minimum amount of difference in retention time allows differentiation of sample components chromatographically. One or more detectors at the exit of the column detect the different compounds when they elute from the column and provide an output signal proportional to amount of the sample component. The different components are shown as “peaks” on a chromatogram where the height and area beneath the peak corresponds to the amount of the compound.

A thermal conductivity detector is widely used to provide the output signal referred to. In a simple form, a thermal conductivity detector includes a cell having an electrically heated element suspended in a cavity. As an example only, the element may be a filament, or another heated structure. As the output from the column flows through the cavity, the rate at which heat flows from the heated element to the wall of the cavity varies with the thermal conductivities of the gases in the cavity. The thermal conductivity of the carrier gas differs from the thermal conductivities of the sample gases, and the thermal conductivities of the sample gases mixed with carrier gas vary with the concentration of the sample gas in the carrier gas. Means are provided for deriving a signal that varies with the rate of heat flow. Accordingly, an output signal of the cell has a baseline value when carrier gas is flowing through its cavity and peaks when the concentrations of the respective sample gases are flowing through the cavity.

A common design for a thermal conductivity detector cell uses multiple elements. Configurations for a thermal conductivity detector cell include four heated elements, or two heated elements and two fixed resistors or one heated element and three fixed resistors. The heated elements and resistors are connected together in a bridge circuit, such as a “Wheatstone Bridge” and powered symmetrically in which two heated elements, or one heated element in the case of a detector cell having fixed resistors, are located in a sample gas stream and the remaining two, or one, heated elements are located in a reference gas stream. In the case of a system with a single heated element the carrier and reference gas may be alternately switched over the heated element. The output is taken across the bridge and indicates the difference between the resistance of the sample element and the resistance of the reference elements due to variation in the thermal conductivity of the gas mixture passing over the elements.

However, in a common TCD design the presence of the sample gas changes the temperature of the element and disrupts the thermal balance of the system. The change in temperature of the element is a potential cause for several adverse effects including changes in the characteristics of the sample element and changes to the nature of the sample, which can skew the results of the analysis. Therefore, it would be desirable to maintain a thermal conductivity detector element at a constant temperature and to maintain the power input to the detector constant and maintain the temperature of the detector body constant.

### SUMMARY

According to an embodiment, a thermal conductivity detector (TCD) includes a detector cell body having a plurality of fluid cavities, at least one detector filament associated with each of the plurality of fluid cavities, and a control circuit associated with each of the at least one detector filaments, wherein the control circuit varies the power to the at least one detector filament to maintain the at least one detector filament at a constant temperature.

Other embodiments of the thermal conductivity detector having compensated constant temperature elements will be discussed with reference to the figures and to the detailed description of the preferred embodiments.

### BRIEF DESCRIPTION OF THE FIGURES

The invention will be described by way of example, in the description of exemplary embodiments, with particular reference to the accompanying figures.

FIG. 1A is a schematic diagram illustrating an embodiment of a detector cell.

FIG. 1B is a planar view of the detector cell of FIG. 1A.

FIG. 2 is a schematic diagram illustrating a detector circuit that can be used to control the temperature of a sample element and a reference element and generate an output in the detector cell of FIGS. 1A and 1B.

FIG. 3 is a block diagram illustrating an embodiment of a power compensation circuit that can be used with the detector circuit of FIG. 2.

FIG. 4 is a block diagram illustrating an embodiment of a temperature compensation circuit that can be used with the detector circuit of FIG. 2.

FIG. 5 is a block diagram illustrating a simplified gas chromatograph, which is one possible device in which the embodiments of the thermal conductivity detector may be implemented.

FIG. 6 is a flow chart illustrating the operation of an embodiment of the detector circuit of FIG. 2.

FIG. 7 is a flow chart illustrating the operation of an embodiment of the power compensation circuit of FIG. 3.

FIG. 8 is a flow chart illustrating the operation of an embodiment of the temperature compensation circuit of FIG. 4.

### DETAILED DESCRIPTION

While described below as used in a thermal conductivity detector having particular characteristics, the thermal conductivity detector having a compensated constant temperature element can be used in any thermal conductivity detector having one or more elements and where it is desirable to precisely control the temperature of an element, or elements, the amount of power supplied to the detector and the temperature of the detector.

As will be described below, the thermal conductivity detector having a compensated constant temperature element can be used to precisely control the temperature of the sample element the power supplied to the detector and the temperature of the detector.

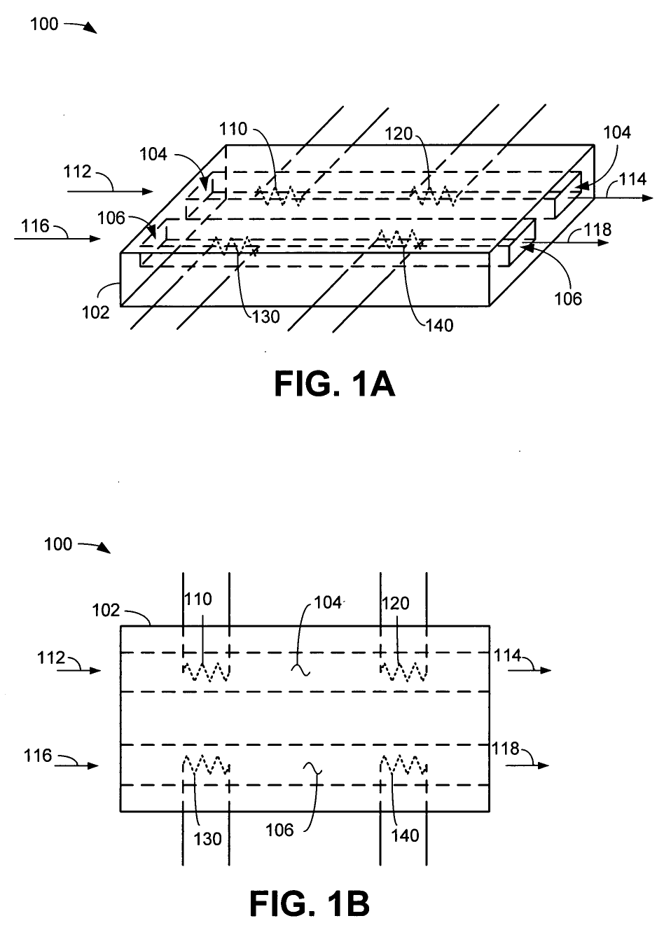

FIG. 1A is a schematic diagram illustrating an embodiment of a detector cell 100. The detector cell 100 generally includes a body 102 into which a pair of cavities to 104 and 106 are formed. In an embodiment, the body 102 can be fabricated from a planar structure such as silicon, into which the cavities 104 and 106 are formed. The cavities 104 and 106 can be, for example, etched into the silicon, or can be formed using other methods. In this example, the cavity 104 is referred to as a sample cavity and the cavity 106 is referred to as a reference cavity. Although omitted from FIG. 1A, the output of a gas chromatograph column can be provided to the sample cavity 104, while a carrier gas can be provided as a reference gas to the reference cavity 106.

The detector cell 100 also includes, in this example, variable resistances 110, 120, 130, and 140. The variable resistances 110, 120, 130, and 140 have a characteristic such that the resistance changes monotonically with temperature. The variable resistances 110, 120, 130, and 140 can be formed in the body 102 as etched structures, and are also referred to as detector filaments. A detector filament located in the sample cavity 104 is referred to as a sample filament and a detector filament located in the reference cavity 106 is referred to as a reference filament.

As used in this description, the term “filament” is used to describe a particular type of heated element. However, the term “filament” is not intended to be limiting. Any heated element can be used according to the principles of the thermal conductivity detector having a compensated constant temperature element described herein. In this example, the sample cavity 104 and the reference cavity 106 each have two variable resistances, but this is not a requirement. A glass lid can be secured over the silicon structure, thus forming the body 102, the sample cavity 104 and the reference cavity 106. It should be mentioned that other structures can be used to form the detector cell 100, so long as at least one variable resistance is located in the sample cavity 104 and one variable resistance is located in the reference cavity 106. It should further be noted that a single variable resistance can be used in a system in which the sample and reference gasses are alternately switched across the element.

The variable resistances can be formed as described above, or can be other resistive structures, so long as the resistance of each of the variable resistances 110, 120, 130, and 140 intrinsically vary in a regulated way as a function of the amount of power provided to the variable resistances 110, 120, 130 and 140. In this example, the variable resistances 110 and 120 can be referred to as sample filaments, or sample elements, and the variable resistances 130 and 140 can be referred to as reference filaments, or reference elements. In an embodiment, the power supplied to at least one sample filament is adjusted to maintain constant temperature of the sample filament that is exposed to sample gas.

In this example, the flow of the reference gas through the detector cell 100 is illustrated using the arrows 112 and 114 and the flow of the sample gas through the detector cell 100 is illustrated using the arrows 116 and 118. However, this flow direction is arbitrary.

FIG. 1B is a planar view of the detector cell 100 of FIG. 1A. The variable resistances 110 and 120 are located in the sample cavity 104 and the variable resistances 130 and 140 are located in the reference cavity 106. As a reference gas passes through the reference cavity 106, the reference gas envelops the variable resistances 130 and 140. A reference gas can be, for example, a carrier gas such as helium, hydrogen, nitrogen, etc. Similarly, as a sample gas, which includes a carrier gas and a sample material, flows through the sample cavity 104, the sample gas envelops the variable resistances 110 and 120. As the output from the column (not shown) flows through the sample cavity 104, the rate at which heat flows from the sample filament 110 varies with the thermal conductivities of the gases in the sample cavity 104. The thermal conductivity of the carrier gas differs from the thermal conductivities of the sample gases, and the thermal conductivities of the sample gases mixed with carrier gas vary with the concentration of the sample gas in the carrier gas.

In accordance with an embodiment of the thermal conductivity detector having a compensated constant temperature element, as the sample gas envelops the sample filament 110, the temperature of the sample filament 110 will change. As will be described below, the amount of power provided to the sample filament 110 when a sample is present will be changed proportionally with the change in the temperature of the sample filament. In this manner, the temperature of the sample filament 110 remains constant.

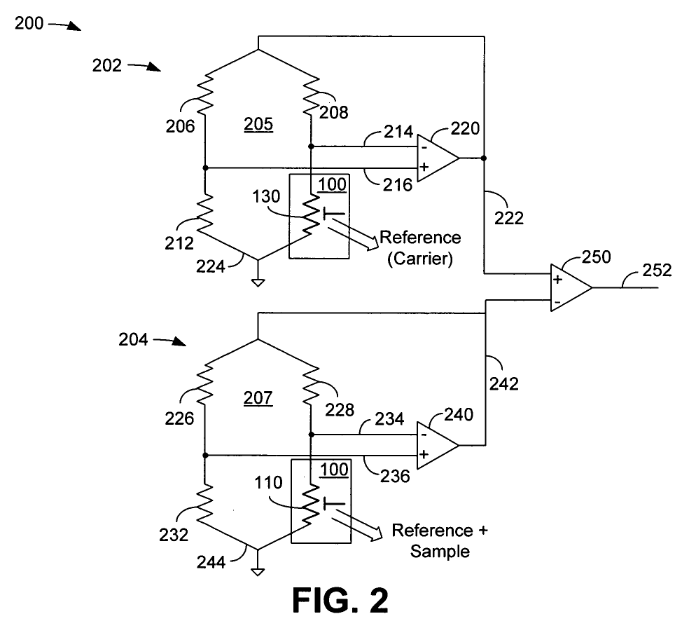

FIG. 2 is a schematic diagram illustrating a detector circuit 200 that can be used to control the temperature of a sample element and a reference element and generate an output in the detector cell 100 of FIGS. 1A and 1B. The detector circuit 200 includes a reference circuit 202 and a sample circuit 204. The reference circuit 202 includes the reference filament 130 arranged in a bridge circuit with fixed resistances 206, 208 and 212. The arrangement of resistances is commonly referred to as a “Wheatstone Bridge,” or bridge 205. The fixed resistances 206, 208 and 212 are located outside of the detector cell 100 (FIG. 1A) and can be discrete resistances, resistors, or other resistive elements. The sample circuit 204 includes the sample filament 110 and fixed resistances 226, 228 and 232. The circuit arrangement of the sample circuit 204 is also referred to as a Wheatstone Bridge, or bridge 207. The fixed resistances 226, 228 and 232 are located outside of the detector cell 100 (FIG. 1A) and can be discrete resistances, resistors, or other resistive elements.

The reference circuit 202 also includes an operational amplifier (op-amp) 220. The inverting input of the operational amplifier 220 is connected between the fixed resistance 208 and the reference filament 130 via connection 214. The non-inverting input of the operational amplifier 220 is connected between the fixed resistance 206 and the fixed resistance 212 via connection of 216.

The sample circuit 204 includes an operational amplifier 240. The inverting input of the operational amplifier 240 is connected between the fixed resistance 228 and the sample filament 110 via connection 234. The non-inverting input of the operational amplifier 240 is connected between the fixed resistance 226 and the fixed resistance 232 via connection 236.

The output of the reference circuit 202 on connection 222 is stable only when the ratio of the resistances 206 and 212 is the same value as the ratio of the resistances 208 and 130. Similarly, the output of the sample circuit 204 on connection 242 is stable only when the ratio of the resistances 226 and 232 is the same value as the ratio of the resistances 228 and 110.

The operational amplifier 240 provides a feedback signal via connection 242 to control the amount of power supplied to the fixed resistances 226, 228, 232 and the sample filament 110, to keep the bridge 207 balanced and keep the resistance value of the variable resistance 110 constant. This maintains the sample filament 110 at a constant temperature. The operational amplifier 220 provides a feedback signal via connection 222 to control the amount of power supplied to the fixed resistances 206, 208, 212 and the reference filament 130 to keep the bridge 205 balanced and keep the resistance value of the variable resistance 130 constant. In this manner, the detector circuit 200 maintains the sample filament 110 at a constant resistance and at a constant temperature.

As a sample gas envelops the sample filament 110, the temperature of the sample filament 110 will change. By varying the power supplied to the bridge 207 by the output of the operational amplifier 240, the temperature of the sample filament 110 is kept constant. By varying power to the bridge 207, only the variable resistance 110 will change in resistance. The power output of the operational amplifier 240 on connection 242 is controlled by the signal on connections 234 and 236 so as to maintain the sample filament 110 at a constant temperature. In this manner, the power (i.e. the voltage signal) on connection 242 becomes a measure of the thermal conductivity of the material passing over the sample filament 110.

The output of the reference circuit 202 is provided via connection 222 to the non-inverting input of a differential amplifier 250. The output of the sample circuit 204 on connection 242 is provided to the inverting input of the differential amplifier 250. The differential amplifier 250 determines the difference between the output of the reference circuit 202 and the sample circuit 204 and provides a signal on connection 252.

The reference filament 130 is exposed only to reference gas and remains at a constant temperature. Because the reference filament 130 remains at a constant temperature the signal on connection 252 is dependent upon the difference in the temperature between the sample filament 110 and the wall of the sample cavity 104 within which the sample filament 110 is located. The amount of energy transferred from the sample filament 110 to the cavity wall is dependent on the thermal conductivity of the gas that is located between the sample filament 110 and the wall of the sample cavity 104. The output of the detector circuit 200 on connection 252 is the difference between the energy used to balance the reference filament 130 and a sample filament 110. The signal on connection 252 is representative of the thermal conductivity of the sample enveloping the sample filament 110.

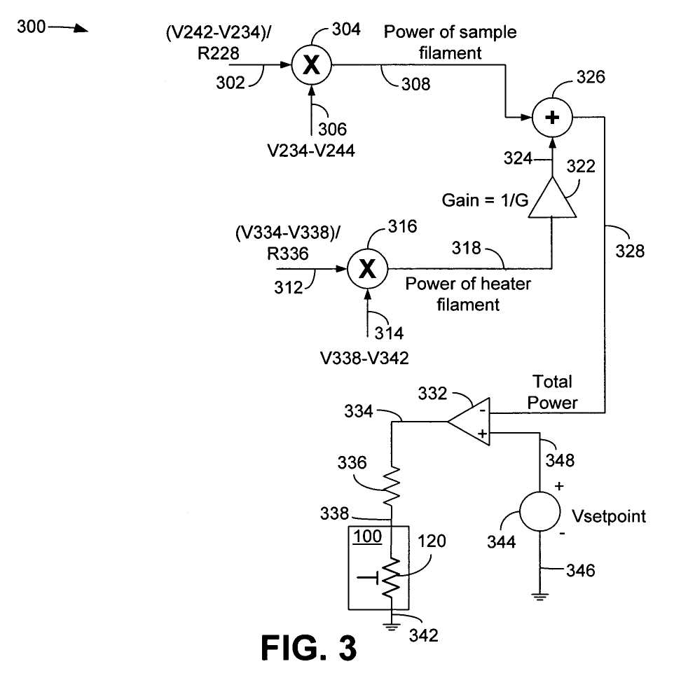

FIG. 3 is a block diagram illustrating an embodiment of a power compensation circuit 300 that can be used with the detector circuit 200 of FIG. 2. It is desirable to keep the temperature of the wall in the sample cavity 104 (FIG. 1A) constant. This can be accomplished by keeping the total power supplied to the detector cell 100 constant.

The power compensation circuit 300 includes a heating element that is located in the vicinity of the sample filament 110. The heating element can be any heating element located in the vicinity of the sample filament 110. In this example, the detector cell 100 (FIGS. 1A and 1B) includes additional variable resistances 120 and 140. Therefore, for simplicity of illustration, the heating element is illustrated as the variable resistance 120. However, the heating element can be either one, or a combination of the variable resistances 130 and 140. Alternatively, the heating element need not be one of the variable resistances in the detector cell 100, but can be any heating element located in the vicinity of the sample filament 110.

The power compensation circuit 300 also includes an operational amplifier 332, the output of which on connection 334 is connected to a heater resistance 336. The heater resistance 336 is connected via connection 338 to the variable resistance 120.

The power compensation circuit 300 also includes a multiplier 304. The multiplier 304 receives as a first input signal a current derived by dividing the voltage across the resistor 228 (FIG. 2, the voltage between nodes 242 and 234) by the resistance value of the resistor 228. The multiplier 304 also receives as input the voltage across the sample filament 110 (FIG. 2, the voltage between nodes 234 and 244). The output of the multiplier 304 on connection 308 is a signal representing the power consumed by the sample filament 110. The signal representing the power consumed by the sample filament may alternatively come from other locations in the detector circuit 200.

The power compensation circuit 300 also includes a multiplier 316. A first input to the multiplier 316 is a current signal derived by dividing the voltage across the resistance 336 (the voltage between nodes 334 and 338) by the value of the resistance 336. Another input to the multiplier 316 is a voltage signal representing the voltage across the variable resistance 120 (the voltage between nodes 338 and 342). The output of the multiplier 316 on connection 318 is a signal representing the power consumed by the variable resistance 120, which is the resistance of the heater.

The signal representing the power consumed by the variable resistance 120 on connection 318 is provided to a gain element 322. The gain element 322 is configurable to adjust the amount of power that is provided to the variable resistance 120 (the heater) so that the amount of power added back to the detector cell 100 can be adjusted based on factors such as, for example, the location of the variable resistance 120 with respect to the sample filament 110, the flow rate through the sample cavity 104 and the reference cavity 106, the design of the detector cell, and other factors.

The power consumed by the sample filament 110, which is indicated on connection 308, is added to the output of the gain element 322 by the adder 326. The output of the adder 326 is a signal representing a variable component of the total power provided to the detector cell 100. This power signal is provided to the inverting input of the operational amplifier 332. A constant DC power source 344 provides a setpoint voltage, Vsetpoint, to the non-inverting input to the operational amplifier 332. The operational amplifier 332 and the heater resistance 120 provide a servo loop that will keep the power signal on connection 328 constant.

As mentioned above, when the sample envelops the sample filament 110, the temperature of the sample filament 110 varies. To keep the temperature of the sample filament 110 constant, the power supplied to the sample filament 110 is changed by the detector circuit 200 as described above in FIG. 2. However, to keep the temperature of the detector cell 100 constant, in an embodiment, it is desirable to keep the total amount of power supplied to the detector cell 100 constant. The power compensation circuit 300 adds or reduces an equivalent amount of power back to the detector cell 100, via the variable resistance 120, based on the amount of power that was changed to the sample filament 110 by the detector circuit 200 as a result of the sample material passing the sample filament 110.

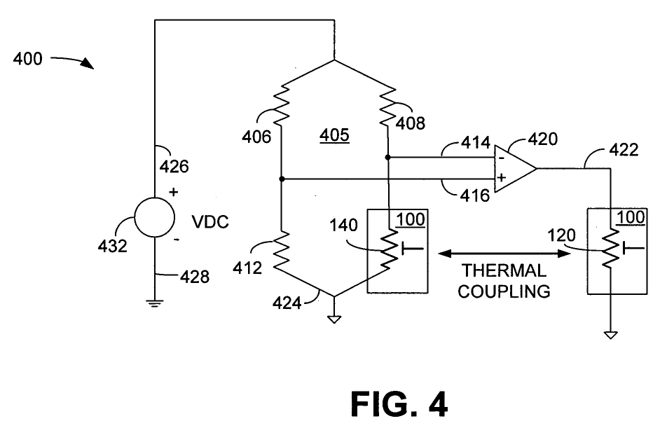

FIG. 4 is a block diagram illustrating an embodiment of a temperature compensation circuit that can be used with the detector circuit of FIG. 2. It is desirable to keep the temperature of the wall in the sample cavity 104 (FIG. 1A) constant. This can be accomplished by keeping the total power supplied to the detector cell 100 constant.

The temperature compensation circuit 400 includes the variable resistance 140 implemented as a temperature sensor. The variable resistance 140 is arranged in a bridge circuit with fixed resistances 406, 408 and 412. The arrangement of resistances is commonly referred to as a “Wheatstone Bridge,” or bridge 405. The fixed resistances 406, 408 and 412 are located outside of the detector cell 100 (FIG. 1A) and can be discrete resistances, resistors, or other resistive elements.

A DC voltage source 432 is coupled to the bridge 405 via connection 426. The variable resistance 140 senses the temperature in the reference cavity 106, which is also a close approximation of the temperature in the sample cavity 104. This is also a close approximation of the temperature of the body 102 of the detector cell 100 (FIG. 1A).

The temperature compensation circuit 400 includes an operational amplifier (op-amp) 420. The inverting input of the operational amplifier 420 is connected between the fixed resistance 408 and the temperature sensor 140 via connection 414. The non-inverting input of the operational amplifier 420 is connected between the fixed resistance 406 and the fixed resistance 412 via connection of 416. The output of the operational amplifier 420 is coupled to the variable resistance 120, which is implemented as a heater element in this embodiment.

The operational amplifier determines the difference in the value of the signals on connections 414 and 416 and provides a difference signal on connection 422. The difference signal controls the amount of heat generated by the variable resistance 120. The heat generated by the variable resistance 120 (the heater) is thermally coupled to the variable resistance 140 (the sensor). The amount of heat provided by the variable resistance 120 is based on the temperature difference between the variable resistance 140 and a reference value provided on connection 416. In this manner, thermal coupling between the variable resistance 120 and the variable resistance 140 maintains the variable resistance 140, and the body 102 of the detector cell 100, at a stable temperature.

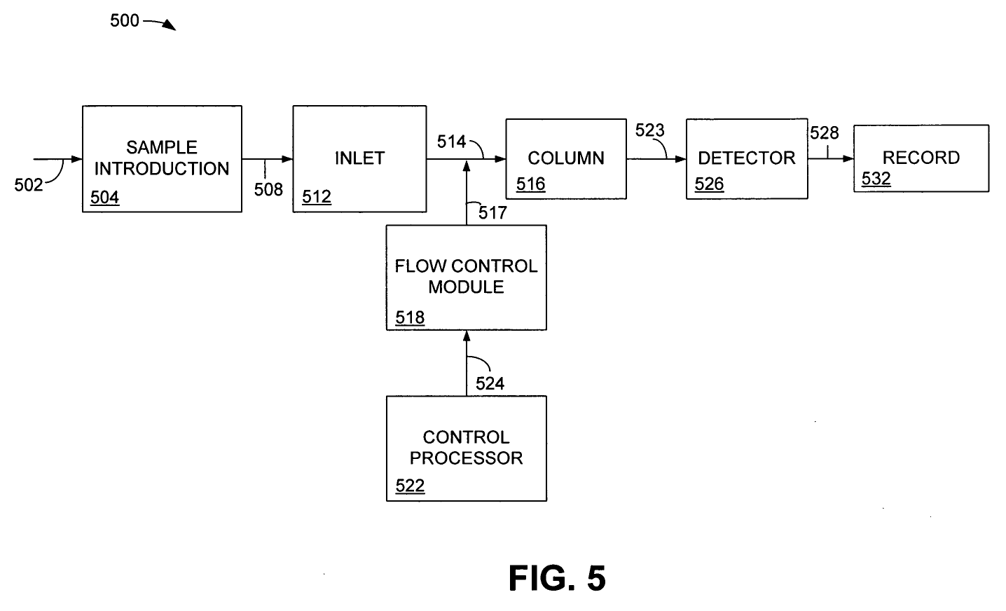

FIG. 5 is a block diagram illustrating a simplified gas chromatograph 500, which is one possible device in which the embodiments of the thermal conductivity detector may be implemented. The gas chromatograph 500 includes a means of introducing a sample. A sample can be introduced via any of several devices known to those skilled in the art. For example, a sample may be introduced via a sample valve 504 which receives a gaseous sample of material to be analyzed via connection 502 and provides the sample via connection 508 to the inlet 512 of a gas chromatograph. The inlet 512 is connected to a chromatographic column 516 via connection 514. A control processor 522 can be coupled to a flow control module 518, via connection 524 to control the flow from the inlet 512 to the chromatographic column 516.

The output of the chromatographic column 516 is directed to a detector 526 via connection 523. The detector 526 can include the detector cell 100, the detector circuit 200, the power compensation circuit 300 and the temperature compensation circuit 400, described above. The output signals from the detector 526 are displayed and/or stored digitally and/or recorded mechanically with a plotter to provide a record 532 of the analytical run.

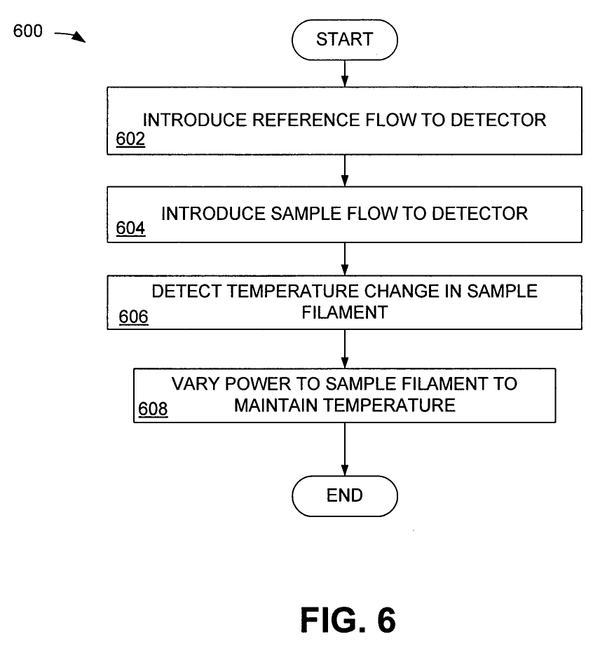

FIG. 6 is a flow chart illustrating the operation of an embodiment of the detector circuit 200 of FIG. 2. The blocks in the flowchart can be performed in the order shown or out of the order shown, or can be performed in parallel. In block 602, a flow of reference gas is introduced to the detector cell 100 (FIG. 1A). In block 604 a flow of sample gas is introduced to the detector cell 100 (FIG. 1A).

In block 606, a change in the temperature of the sample filament 110 is detected by the detector circuit 200 as described above. In block 608, the detector circuit 200 changes the amount of power supplied to the sample filament 110 to maintain the sample filament 110 at a constant temperature.

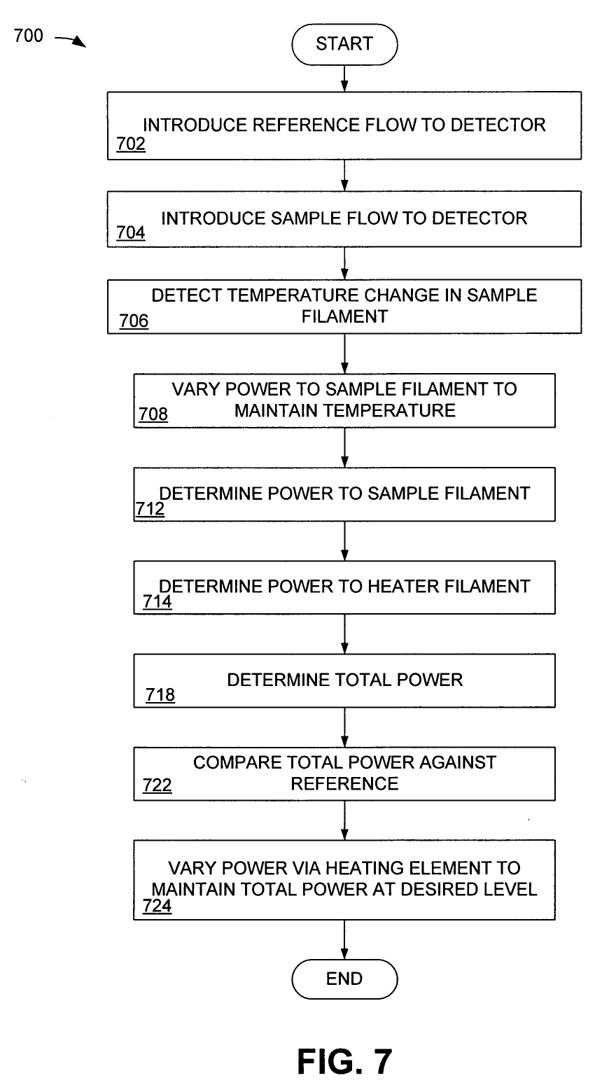

FIG. 7 is a flow chart illustrating the operation of an embodiment of the power compensation circuit 300 of FIG. 3. The blocks in the flowchart can be performed in the order shown or out of the order shown, or can be performed in parallel. In block 702, a flow of reference gas is introduced to the detector cell 100 (FIG. 1A). In block 704 a flow of sample gas is introduced to the detector cell 100 (FIG. 1A).

In block 706, a change in the temperature of the sample filament 110 is detected by the detector circuit 200 as described above. In block 708, the detector circuit 200 changes the amount of power supplied to the sample filament 110 to maintain the sample filament 110 at a constant temperature.

In block 712, the amount of power consumed by the sample filament is determined. In block 714, the amount of power consumed by the heating element (the variable resistance 120) is determined. In block 718, the total power consumed by the sample filament and the heating element is determined. In block 722, the total power is compared against a reference power level (Vsetpoint). In block 724, sufficient power is added to or removed from the detector cell, via the heating element, to maintain the total power supplied to the detector cell at a constant level, thereby maintaining the detector cell at a constant temperature.

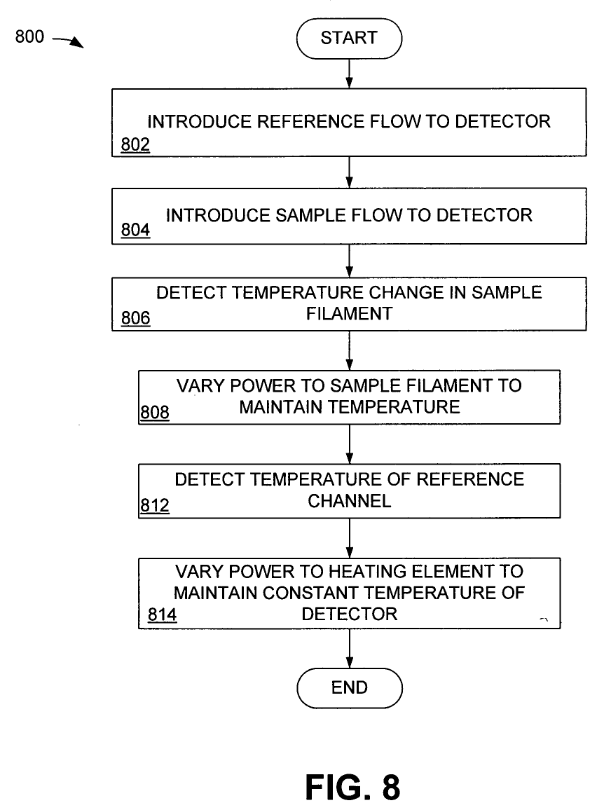

FIG. 8 is a flow chart illustrating the operation of an embodiment of the temperature compensation circuit 400 of FIG. 4. The blocks in the flowchart can be performed in the order shown or out of the order shown, or can be performed in parallel. In block 802, a flow of reference gas is introduced to the detector cell 100 (FIG. 1A). In block 804 a flow of sample gas is introduced to the detector cell 100 (FIG. 1A).

In block 806, a change in the temperature of the sample filament 110 is detected by the detector circuit 200 as described above. In block 808, the detector circuit 200 changes the amount of power supplied to the sample filament 110 to maintain the sample filament 110 at a constant temperature.

In block 812, the temperature of the reference channel 106 (FIG. 1A) is detected by the variable resistance 140 (FIG. 4). In block 814, the power provided to the variable resistance 120 (FIG. 4) is varied based on the temperature of the reference cavity 106 to control the amount of heat generated by the variable resistance 120. The heat generated by the variable resistance 120 is thermally coupled to the variable resistance 140 to control the temperature of the body 102 of the detector cell 100, thereby maintaining the detector cell at a constant temperature.

The foregoing detailed description has been given for understanding exemplary implementations of the invention and no unnecessary limitations should be understood therefrom as modifications will be obvious to those skilled in the art without departing from the scope of the appended claims and their equivalents. Other devices may use the thermal conductivity detector having a compensated constant temperature element described herein.

What is claimed is:

1. A thermal conductivity detector (TCD), comprising:
a detector cell body having a plurality of fluid cavities;
at least one detector element associated with each of the plurality of fluid cavities; and
a control circuit associated with each of the at least one detector elements, wherein the control circuit varies the power to the at least one detector element associated with one of the plurality of fluid cavities to maintain the at least one detector element at a constant temperature.

2. The thermal conductivity detector of claim 1, wherein a difference in the power supplied to each of the at least one detector element associated with each of the plurality of fluid cavities is a voltage signal that is representative of the thermal conductivity of a sample in contact with the at least one detector element.

3. The thermal conductivity detector of claim 2, further comprising:
an additional detector element; and
a circuit associated with the additional detector element, the circuit configured to provide an amount of power to the additional detector element that compensates for the amount of power that is varied to the at least one detector element.

4. The thermal conductivity detector of claim 3, in which the circuit associated with the additional detector element comprises an operational amplifier configured to receive a set point signal and a signal representative of the power supplied to the at least one detector element and the additional detector element.

5. The thermal conductivity detector of claim 4, further comprising an adjustable gain element configured to adjust the amount of power provided to the additional detector element.

6. The thermal conductivity detector of claim 5, in which the amount of power provided to the additional detector element is adjusted based on the position of the additional detector element with respect to the at least one detector element.

7. The thermal conductivity detector of claim 2, further comprising:
an additional detector element; and
a circuit associated with the additional detector element, the circuit configured to provide an amount of power to the additional detector element that compensates for temperature change in the at least one detector element.

8. A method for maintaining an element of a thermal conductivity detector at a constant level, comprising:
introducing a reference flow to a reference element located in a detector;
introducing a sample flow to a sample element located in the detector;
detecting a temperature change in the sample element; and
varying power to the sample element to maintain the sample element at a constant temperature.

9. The method of claim 8, further comprising determining a difference in the power supplied to the reference element and the sample element to determine a thermal conductivity of a sample in contact with the sample element.

10. The method of claim 9, further comprising adding to an additional element in the thermal conductivity detector an amount of power that is proportional to an amount of power that is varied to the sample element.

11. The method of claim 10, further comprising determining the amount of power to add to the additional element by comparing a set point signal with a signal that represents the power supplied to the sample element and the power supplied to the additional element.

12. The method of claim 11, further comprising adjusting the amount of power provided to the additional element.

13. The method of claim 12, further comprising adjusting the amount of power provided to the additional element based on the position of the additional element with respect to the sample element.

14. The method of claim 13, further comprising adding to an additional element in the thermal conductivity detector an amount of power that is proportional to the temperature of the thermal conductivity detector.

15. A thermal conductivity detector (TCD) for use with a gas chromatograph, comprising:
an inlet;
a column coupled to the inlet;
a detector cell body having a plurality of fluid cavities;
at least one detector element associated with each of the plurality of fluid cavities; and
a control circuit associated with each of the at least one detector elements, wherein the control circuit varies the power to the at least one detector element associated with one of the plurality of fluid cavities to maintain the at least one detector element at a constant temperature.

16. The thermal conductivity detector of claim 15, wherein a difference in the power supplied to each of the at least one detector element associated with each of the plurality of fluid cavities is a signal that is representative of the thermal conductivity of a sample in contact with the at least one detector element.

17. The thermal conductivity detector of claim 16, further comprising:
an additional detector element in the vicinity of the first detector filament; and
a circuit associated with the additional detector element, the circuit configured to provide an amount of power to the additional detector element that is proportional to an amount of power that is varied to the at least one detector element.

18. The thermal conductivity detector of claim 17, in which the circuit associated with the additional detector element comprises an operational amplifier configured to receive a set point signal and a signal representative of the power supplied to the at least one detector element and the additional detector element.

19. The thermal conductivity detector of claim 18, further comprising an adjustable gain element configured to adjust the amount of power provided to the additional detector element based on the position of the additional detector element with respect to the at least one detector element.

20. The thermal conductivity detector of claim 16, further comprising:
an additional detector element; and
a circuit associated with the additional detector element, the circuit configured to provide an amount of power to the additional detector element that compensates for temperature change in the at least one detector element.
